(19) United States
(12) Patent Application Publication
(10) Pub. No.: US 2023/0062639 A1
(43) Pub. Date: Mar. 2, 2023

(54) AIRBAG FOR AN AIRBAG ARRANGEMENT AND AIRBAG ARRANGEMENT OF A VEHICLE SEAT

(71) Applicants: Audi AG, Ingolstadt (DE); ZF Automotive Germany GmbH, Alfdorf (DE)

(72) Inventors: Bernd JAKOBS, Nürnberg (DE); Franz FÜRST, Buxheim (DE); Walter KRÖNES, Gaimersheim (DE); Christoph GRUNDHEBER, Gaimersheim (DE); Niko EDELMANN, Ingolstadt (DE); Werner FREISLER, Schwäbisch Gmünd (DE); Benjamin WEIMER, Spraitbach (DE)

(73) Assignees: Audi AG, Ingolstadt (DE); ZF Automotive Germany GmbH, Alfdorf (DE)

(21) Appl. No.: 17/779,477

(22) PCT Filed: Oct. 26, 2020
(86) PCT No.: PCT/EP2020/080042

§ 371 Date: May 24, 2022

(30) Foreign Application Priority Data
Dec. 16, 2019 (DE) 10 2019 134 482.4

(51) Int. Cl. B60R 21/207; B60R 21/231

(52) U.S. Cl. CPC B60R 21/207; B60R 21/231

(57) ABSTRACT

An airbag for an airbag arrangement of a vehicle seat of vehicle includes an inflatable cover. The inflatable cover includes an upper part facing a seat surface, a lower part facing a vehicle floor, and a casing part interconnecting the upper part and the lower part. The inflatable cover folds during a standby state and inflates during an operational state. During the inflation process, the upper part of the inflatable cover applies a force against the thighs or the pelvic region of an occupant sitting on the vehicle seat to lift these the thighs or the pelvic region of the occupant. The inflatable cover includes at least one cutout to guide an air current through the airbag. The casing part is shaped during the inflation process to define a support surface for engaging the thighs or the pelvic region of the occupant sitting on the vehicle seat.

### TECHNICAL FIELD

The present invention relates to an airbag for an airbag arrangement of a vehicle seat according to the embodiments described herein. Furthermore, the present invention relates to a corresponding airbag arrangement of a vehicle, comprising the airbag according to the embodiments described herein.

### BACKGROUND

Airbags of airbag arrangements and belt straps of restraint apparatuses are currently used in vehicles in order to adequately protect the occupant in an upright seating position in the event of a collision. In order to allow the occupants to assume a comfortable position during piloted driving in the future, novel restraint systems and their integration into the vehicle are required. In order to protect the occupant, in particular in a comfort position in which the occupant assumes a horizontal lying position, for example, it is necessary to supplement additional protective apparatuses. In addition, existing comfort features such as seat heating, seat ventilation, etc. are still to be used.

Airbags, which are arranged in a seat cushion of a vehicle seat and have an inflatable cover, are known in numerous variations. In a standby state, the inflatable cover can be folded together in the seat cushion and, in an operational state, it can be arranged in an inflated state in the seat cushion. Corresponding airbag arrangements having such an airbag are also known in numerous variations.

A vehicle seat having an airbag arrangement is known from US 2012 0007 407 A1. The vehicle seat comprises a seat cushion and a seat backrest and an airbag arrangement arranged in the seat cushion. The interior airbag arrangement comprises a gas generator and an airbag, with the inflator inflating the airbag in an accident situation. The airbag comprises different regions, with one region in the inflated state having a greater extent in the vehicle vertical direction than another region. As a result of this design, the legs of an occupant sitting or lying on the seat cushion can be lifted in the accident situation, and it can be made more difficult for the occupant to slip through under the belt strap.

A vehicle seat with a generic airbag arrangement is known from US 2014/0346819 A1. The vehicle seat comprises a seat cushion and a seat backrest, as well as an airbag arrangement arranged within the seat cushion. The interior airbag arrangement comprises a gas generator and an airbag of the generic type, the gas generator inflating the airbag in an accident situation. The airbag comprises an upper part facing a seat surface and a lower part facing a vehicle floor. The airbag is designed to be U-shaped or O-shaped, with a front region of the airbag in the inflated state being able to have a greater extent in the vehicle vertical direction than a rear region in the direction of travel. The legs of an occupant sitting or lying on the seat cushion can be lifted by the airbag in the accident situation, and it can be made more difficult for the occupant to slip through under the belt strap.

A disadvantage of the known airbags for an airbag arrangement of a vehicle seat can be considered that, during the inflation process, they only allow linear force transmission due to the round cross section in order to lift the thighs and/or a pelvic region of an occupant sitting on the vehicle seat.

### SUMMARY OF INVENTION

An object of the present invention is providing an airbag for an airbag arrangement of a vehicle seat and a corresponding airbag arrangement, comprising an inflatable cover, the geometric shape of which can be easily adapted and allows better introduction of force in order to lift the thighs and/or the pelvic region of an occupant sitting on the vehicle seat.

This object is achieved by an airbag with the features of the embodiments described herein and by an airbag arrangement with the features of the embodiments described herein. Advantageous embodiments with expedient developments of the present invention are specified in detail below.

In order to provide an airbag for an airbag arrangement of a vehicle seat and a corresponding airbag arrangement, comprising an inflatable cover, the geometric shape of which can be easily adapted and allows better introduction of force in order to lift the thighs and/or the pelvic region of an occupant sitting on the vehicle seat, at least one casing part interconnects an upper part, via which upper part a force can be introduced into the thighs and/or the pelvic region of an occupant sitting on the vehicle seat during the inflation process in order to lift these body parts, and a lower part of a cover of the airbag, wherein the shape and dimensions of the at least one casing part during the inflation process of the cover predetermine a support surface for the thighs and/or the pelvic region of the occupant sitting on the vehicle seat, so that a planar introduction of force takes place for lifting the thighs and/or the pelvic region.

An airbag is understood below to mean an assembly with an inflatable cover and at least one inlet valve, the airbag being arranged in a seat cushion of a vehicle seat. In the operational state, the airbag changes the shape of the seat cushion in such a way that it is prevented or at least made more difficult for an occupant sitting or lying on the seat cushion to slip through under a belt strap. The inflatable cover is folded together in a standby state and inflated in an operational state and substantially dictates the shape of the airbag in the standby state and in the operational state. In preferred embodiments of the airbag in the folded state, only the casing part of the cover has a fold and the upper part and the lower part lie substantially flat on top of one another. In comparison to an airbag, which consists only of an upper part and a lower part, the at least one casing part has the effect that the height of the inflated airbag can be increased or controlled independently of the lower part and/or the upper part. The fluid from an inflation apparatus can be introduced into the cover via the inlet valve. In this case, a shape of the seat cushion changes. The inflatable cover can be reinforced with reinforcement elements. The cover also comprises at least one cutout through which an air current generated by a ventilation arrangement can flow.

An airbag arrangement is understood below to mean an assembly with an airbag having an inflatable cover. The cover is folded together in the standby state and inflated in the operational state and is arranged in a seat cushion of a vehicle seat. At least one inflation apparatus inflates the inflatable cover of the airbag in an accident situation. The inflation apparatus may include a suitable gas generator and suitable connecting elements. In addition, the airbag arrangement can be coupled to sensors which, for example, detect a longitudinal position of the vehicle seat and/or an inclination of the seat backrest and/or an accident situation.

A vehicle seat is understood below to mean an assembly having a seat cushion and an adjustable seat backrest, at least one airbag of an airbag arrangement being arranged in the seat cushion. In addition, an inflation apparatus for the at least one airbag and/or a sensor that detects an occupancy of the seat cushion can be arranged in the seat cushion. Furthermore, for example, a ventilation arrangement can be arranged in the seat cushion, which ventilation arrangement ventilates or controls the temperature of the seat cushion.

Advantageously, the geometric shape and dimensions of the inflatable cover can be easily predetermined by the upper part and the lower part in a plane extending in the vehicle transverse direction and in the vehicle longitudinal direction. The geometric shape and dimensions of the inflatable cover in a plane extending in the vehicle transverse direction and in the vehicle vertical direction and in a plane extending in the vehicle longitudinal direction and in the vehicle vertical direction can be easily predetermined by the at least one casing part. In this case, a suitable cover shape can easily be produced for each seat model. In addition, the production of the cover is advantageously facilitated since the shape can be clearly defined by the upper part, the lower part, and the at least one casing part. In addition, the lower part, the upper part, and the at least one casing part can be easily interconnected, for example sewn together. In addition, the lower part advantageously forms a support region on the underside of the cover, so that the cover can be arranged stably in the seat cushion. The upper part advantageously forms a support surface for the thighs and/or the pelvic region of the occupant, with the thighs and/or the pelvic region resting indirectly on the support surface of the cover via the seat surface of the seat cushion. The thighs and/or the pelvic region rest stably during the inflation process and can be lifted by means of the support surface and the associated planar introduction of force. The upper part of the cover can preferably be dimensioned in such a way that the thighs and/or the pelvic region cannot slip sideways from the cover or from the region of the seat surface lifted by the cover. This can advantageously increase the probability that the thighs and/or the pelvic region will be lifted when the cover is inflated. The shape of the at least one casing part can advantageously reduce unwanted deformation of the upper part or unwanted deformation of the lower part and an associated reduction in the support surface for the thighs and/or the pelvic region. The effect of the at least one casing part is that the height of the inflated airbag can be increased or controlled independently of the lower part and/or the upper part. In particular, the inclination of the upper part of the cover in the inflated state can be predetermined via the at least one casing part. The inclination of the upper part can specify the angle between the thighs and/or the pelvic region and an upper body of the occupant, so that the occupant sitting or lying on the seat cushion can at least be made more difficult or prevented from slipping through under a belt strap. The air current generated by the at least one ventilation arrangement can advantageously be guided through the at least one cutout of the inflatable cover of the airbag according to an embodiment of the invention. As a result, the function of the airbag according to an embodiment of the invention and the function of the at least one ventilation arrangement can be combined with one another in an advantageous manner, so that the comfort of the occupants is maintained despite increased safety. Furthermore, the functions of the ventilation arrangement and the functions of a corresponding airbag arrangement according to an embodiment of the invention can be combined with at least one such airbag according to an embodiment of the invention. As a result, the occupant can be protected in an advantageous manner in any seating position without sacrificing the usual seating comfort due to the ventilation arrangement. In addition, the airbag can advantageously be folded together flat during normal driving and arranged in the seat cushion to save space.

In an airbag according to an embodiment of the invention, the inflatable cover can have at least one recess in the region of the at least one casing part and/or the lower part, which recess adapts the inflated cover to an installation environment in the vehicle seat. For example, the at least one casing part and the lower part can have a common indentation in the inflated state, through which indentation a vehicle seat component that is in the way can be bypassed. As a result, the airbag can be adapted to a support geometry in the vehicle seat, for example, and still provide a support surface on the upper part for lifting the thighs and/or the pelvic region of the occupant.

In an airbag according to an embodiment of the invention, the at least one casing part can form a rear part facing the seat backrest, a front part opposite the rear part, and at least two side parts of the cover, with the at least two side parts connecting the front part to the rear part. In this case, the casing part can be designed in multiple pieces, for example the side parts, the front part, and the rear part can be cut out individually and be interconnected. Alternatively, the casing part can be designed in one piece, with different portions of the casing part forming the side parts, the front part, and the rear part. In addition, depending on the geometric shape of the cover, the cover can have a number of casing parts which are not directly interconnected. In this case, no darts or other elements are required on the upper part or the lower part in order to achieve the support surface of the cover for the planar introduction of force, since the shape and dimensions can be predetermined by the casing part in such a way that the planar support surface of the cover is created during the inflation process.

In an airbag according to an embodiment of the invention, the rear part can be designed to be lower than the front part in the vehicle vertical direction, so that the support surface has an inclination in the direction of the seat backrest in the inflated state of the cover. As a result, the thighs and/or the pelvic region can be effectively lifted in an advantageous manner and the occupant sitting or lying on the seat cushion can at least be made more difficult or prevented from slipping through under the belt strap.

In an airbag according to an embodiment of the invention, the at least two side parts can each have two legs which converge at an acute angle, with a first leg being connected to the upper part and a second leg being connected to the lower part. By means of this design of the side parts, a wedge-shaped inclination of the support surface can be easily implemented in an advantageous manner, since the angle between the legs corresponds to the angle of inclination of the upper part. The upper part forms a slope or a wedge-shaped ramp. The length of the legs and the angle between the legs can dictate the inclination of the slope or ramp.

In an airbag according to an embodiment of the invention, the at least one cutout can be designed as a through opening, with the inflatable cover being able to completely or partially enclose the through opening. For example, the cover can be designed to be O-shaped and the through opening can be arranged centrally on the cover, with the through opening being completely surrounded by the cover. Alternatively, the cover can be designed to be U-shaped and partially enclose an internal through opening. An air current of the ventilation arrangement can advantageously be guided through the through opening of the cover.

In an airbag according to an embodiment of the invention, the upper part and the lower part can be designed to be U-shaped or O-shaped. Due to the U-shape and the O-shape, the dimensions of the through opening can be easily predetermined or adapted to the seat model. In this case, the through opening is completely surrounded by the cover in the case of the O-shaped design of the upper part and the lower part, and only partially surrounded by the cover in the case of the U-shaped design of the upper part and the lower part.

In an airbag according to an embodiment of the invention, the casing part can form two outer side parts, two inner side parts, a continuous rear part, and a multi-piece front part in the case of a U-shaped upper part and a U-shaped lower part. Alternatively, the casing part can form two outer side parts, two inner side parts, a continuous front part and a multi-piece rear part. The inner side parts form a wall delimiting the through opening. The multi-piece front part and the multi-piece rear part each comprise two outer elements and a middle element which is arranged offset to the rear between the two outer elements.

In an airbag according to an embodiment of the invention, the inflatable cover can have two casing parts in the O-shaped design, with an outer casing part forming two outer side parts, a continuous rear part, and a continuous front part. An inner casing part forms two inner side parts, an inner rear part, and an inner front part. In this case, the inner casing part forms the wall delimiting the through opening.

In an airbag arrangement according to an embodiment of the invention, the at least one cutout can guide the air current generated by the ventilation arrangement to a seat surface of the seat cushion. As a result, simple and direct ventilation or temperature control of the seat cushion can advantageously take place without additional components. For example, the air current may impinge on an underside of the seat bottom and flow through a seat cushion material and exit the seat surface.

The advantages described herein for the airbag according to the disclosed embodiments of invention also apply to the airbag arrangement according to the disclosed embodiments of the invention.

The features and feature combinations mentioned above in the description, as well as the features and feature combinations mentioned below in the description of the figures and/or shown only in the figures, can be used not only in the respectively specified combination but also in other combinations or in isolation without departing from the scope of the invention. Embodiments of the invention, which are not explicitly shown or explained in the figures but derive therefrom and can be produced by separated combinations of features from the embodiments explained, are thus to be regarded as included and disclosed.

### BRIEF DESCRIPTION OF THE FIGURES

Embodiments of the invention are shown in the drawing and are explained in more detail in the following description. In the drawing, the same reference signs designate components or elements that perform the same or analogous functions. In the drawings:

FIG. 1 is a schematic perspective representation of an airbag according to a first embodiment of the invention in an inflated operational state;

FIG. 2 is a schematic representation of a casing part of the airbag from FIG. 1;

FIG. 3 is a schematic plan view of the airbag according to a second embodiment of the invention;

FIG. 4 is a schematic representation of an inner casing part of the airbag from FIG. 3;

FIG. 5 is a schematic representation of an outer casing part of the airbag from FIG. 3; and

FIG. 6 is a schematic block diagram of an airbag arrangement of a vehicle seat according to an embodiment of the invention.

### DETAILED DESCRIPTION OF THE FIGURES

As can be seen from FIGS. 1 to 5, an airbag 10, 10A, 10B for an airbag arrangement 40 of a vehicle seat 50 comprises an inflatable cover 20, 20A, 20B which has an upper part 22, 22A, 22B facing a seat surface and a lower part 24, 24A, 24B facing a vehicle floor base. The inflatable cover 20, 20A, 20B is folded together in a standby state and is inflated in an operational state, wherein, during the inflation process, the inflatable cover 20, 20A, 20B introduces a force via the upper part 22, 22A, 22B into the thighs and/or a pelvic region of an occupant sitting on the vehicle seat 50 in order to lift these body parts. In addition, the inflatable cover 20, 20A, 20B has at least one cutout 30 between the lower part 24, 24A, 24B and the upper part 22, 22A, 22B, through which an air current 32 can be guided.

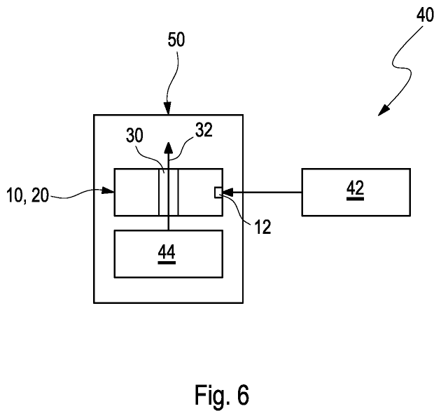

As can be seen from FIG. 6, a corresponding airbag arrangement 40 comprises the airbag 10 having the inflatable cover 20, 20A, 20B, wherein the inflatable cover 20, 20A, 20B is arranged folded together in a standby state and inflated in an operational state in a seat cushion of the vehicle seat 50, wherein at least one inflation apparatus 42 inflates the inflatable cover 20, 20A, 20B of the airbag 10 in an accident situation

According to an embodiment of the invention, at least one casing part 23, 23A, 23Ba, 23Bi interconnects the upper part 22, 22A, 22B and the lower part 24, 24A, 24B of the cover 20, 20A, 20B, wherein the shape and dimensions of the at least one casing part 23, 23A, 23Ba, 23Bi during the inflation process of the cover 20, 20A, 20B predetermine a support surface 29 for the thighs and/or the pelvic region of the occupant sitting on the vehicle seat, so that a planar introduction of force takes place for lifting the thighs and/or the pelvic region.

As can also be seen from FIG. 6, the inflation apparatus 42 can comprise a gas generator which is arranged in a seat frame of the vehicle seat 50, wherein the released fluid can be fed to the airbag 10, 10A, 10B, for example by means of a gas drive tube or another suitable gas supply, such as a fabric hose or the like. In an alternative embodiment, the gas generator can be integrated in the airbag 10, 10A, 10B. The at least one cutout 30 of the cover 20, 20A, 20B guides the air current 32 generated by a ventilation arrangement 44 to the seat surface of the seat cushion. In this case, in particular an underside of the seat surface 14 is subjected to the air current, and the air current 32 can exit from the seat surface. In addition to the inflation apparatus 42, the airbag arrangement 40 according to an embodiment of the invention that is shown has sensors (not shown). These sensors can, for example, detect a longitudinal position of the vehicle seat and/or an inclination of the seat backrest. Furthermore, sensors can be provided which detect whether the vehicle seat 50 is occupied by an occupant. If the vehicle seat 50 is unoccu-pied, there is no need to trigger the airbag 10, 10A, 10B according to the disclosed embodiments of the invention in an accident situation. Even in the case of a vehicle seat in a normal position with the seat backrest in an upright position, the airbag 10, 10A, 10B according to the disclosed embodiments of the invention does not need to be triggered in an accident situation. In addition, surroundings sensors (not shown) can detect an accident situation and activate the inflation apparatus 42.

As can further be seen from FIGS. 1 to 5, the shape of the cover 20, 20A, 20B dictates the shape of the airbag 10, 10A, 10B. Reinforcement elements or an inlet valve 12 may be arranged on the cover 20, 20A, 20B, which inlet valve couples the inflation apparatus 42 to the inflatable cover 20, 20A, 20B. The dimensions of the upper part 22, 22A, 22B and the lower part 24, 24A, 24B are adapted to dimensions of the corresponding seat cushion.

As can also be seen from FIGS. 1 to 5, the at least one casing part 23, 23A, 23Ba, 23Bi forms a rear part 26, 26A, 26Ba, 26Bi facing a seat backrest, a front part 28 opposite the rear part 26, 26A, 26Ba, 26Bi, 28A, 28Ba, 28Bi, and at least two side parts 27Aa, 27Ai, 27Ba, 27Bi of the cover 20, 20A, 20B, wherein the at least two side parts 27Aa, 27Ai, 27Ba, 27Bi connect the front part 28, 28A, 28Ba, 28Bi to the rear part 26, 26A, 26Ba, 26Bi. In this case, the at least one casing part 23, 23A, 23Ba, 23Bi predetermines the shape and the dimensions of the inflated airbag 10, 10A, 10B in the vehicle vertical direction z. The at least one casing part 23, 23A, 23Ba, 23Bi thus causes the height of the inflated airbag 10, 10A, 10B to be increased or controlled independently of the lower part 24, 24A, 24B and/or the upper part 22, 22A, 22B. The corresponding rear part 26, 26A, 26Ba, 26Bi is designed to be lower than the corresponding front part 28, 28A, 28Ba, 28Bi in the vehicle vertical direction z, so that the support surface 29 has an inclination towards the seat backrest in the inflated state of the cover 20, 20A, 20B. By means of the height difference formed between the front part 28, 28A, 28Ba, 28Bi and the corresponding rear part 26, 26A, 26Ba, 26Bi, the thighs and/or the pelvic region of an occupant lying or sitting on the seat cushion are lifted, the thighs and the pelvic region being arranged on the seat cushion. The at least two side parts 27Aa, 27Ai, 27Ba, 27Bi each have two legs 27.1Aa, 27.2Aa, 27.1Ai, 27.2Ai, 27.1Ba, 27.1Bi, 27.2Ba, 27.2Bi which converge at an acute angle. A first leg 27.1Aa, 27.1Ai, 27.1Ba, 27.1Bi is connected to the upper part 22, 22A, 22B, and a second leg 27.2Aa, 27.2Ai, 27.2Ba, 27.2Bi is connected to the lower part 24, 24A, 24B. The acute angle between the two legs 27.1Aa, 27.2Aa, 27.1Ai, 27.2Ai, 27.1Ba, 27.1Bi, 27.2Ba, 27.2Bi predetermines the inclination of the upper part 22, 22A, 22B or the support surface 29 of the upper part 22, 22A, 22B. The lower part 24, 24A, 24B forms a support region which allows the lower part 24, 24A, 24B to be adapted to the installation conditions in the vehicle seat 50.

In an alternative embodiment (not shown), the inflatable cover 20, 20A, 20B has at least one cutout in the region of the at least one casing part 23, 23A, 23Ba, 23Bi and/or the lower part 24, 24A, 24B, which recess adapts the inflated cover 20, 20A, 20B to an installation environment in the vehicle seat 50. The at least one casing part 23, 23A, 23Ba, 23Bi and the lower part 24, 24A, 24B can have a common indentation, through which a vehicle seat component that is in the way can be bypassed. As a result, the airbag 10, 10A, 10B can be adapted, for example, to a support geometry in the vehicle seat 50 and still provide a support surface on the upper part 22, 22A, 22B and/or pelvic region for lifting the thighs and/or the pelvic region of the occupant. An underside of the seat cushion rests partially on the support surface 29 of the upper part 22, 22A, 22B. The seat surface on which the thighs and/or the pelvic region of the occupant rest is arranged over the support surface 29 of the upper part 22, 22A, 22B, so that the thighs and/or the pelvic region indirectly rest flat on the support surface 29 of the upper part 22, 22A, 22B and thereby also have the inclination of the upper part 22, 22A, 22B. As a result, in the inflated state of the cover 20, 20A, 20B, it is at least more difficult or impossible for the occupant to slip through under a belt strap.

As can also be seen from FIGS. 1, 3, and 6, the at least one cutout 30 is designed as a through opening 30A, 30B, with the inflatable cover 20, 20A, 20B completely or partially enclosing the through opening 30A, 30B.

The airbag 10, 10A according to first embodiment of the invention, illustrated in

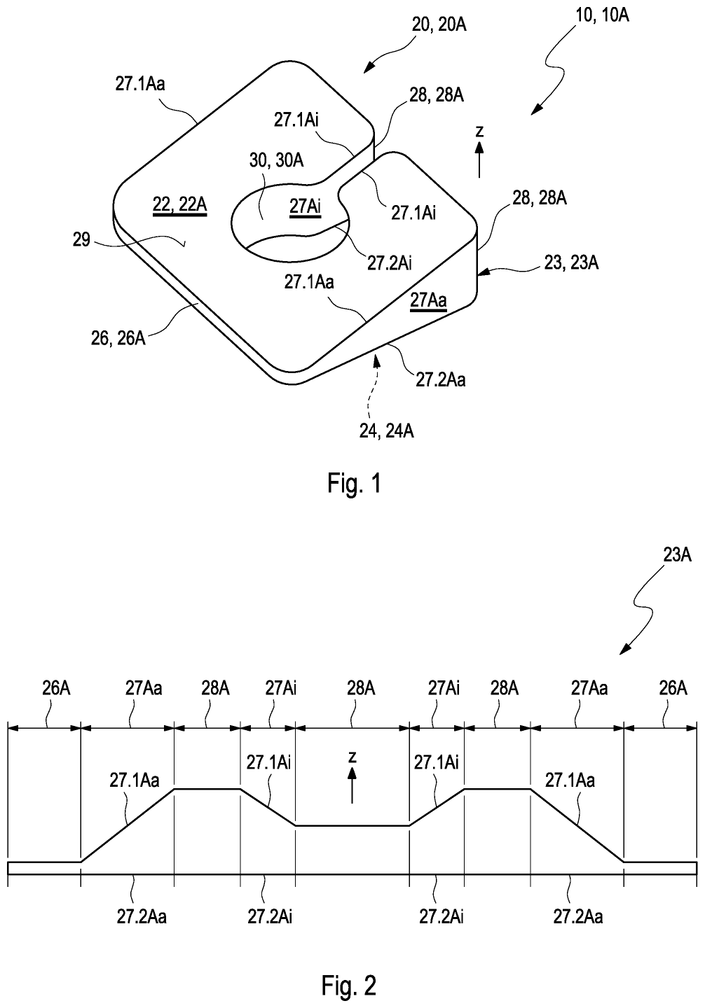

FIGS. 1 and 2, comprises a U-shaped upper part 22, 22A and a U-shaped lower part 24, 24A. The U-shape in this case comprises two legs, which run in the longitudinal direction of the seat cushion, and a web connecting the two legs, which web runs in the transverse direction of the seat cushion. In the illustrated embodiment, the U-shape is open to the front. This means that the connecting web is arranged adjacent to the seat backrest, and end regions of the two legs point away from the seat back. The illustrated airbag 10, 10A according to the first embodiment of the invention has a casing part 23, 23A which forms two outer side parts 27Aa, two inner side parts 27Ai, a continuous rear part 26A, and a multi-piece front part 28A. In an alternative embodiment (not shown), the U-shape is open at the back. This means that the connecting web is arranged adjacent to a front edge of the seat cushion and that the end regions of the two legs point towards the seat backrest. In this case, the casing part forms two outer side parts 27Aa, two inner side parts 27Ai, a continuous front part, and a multi-piece rear part. The multi-piece front part 28A and the multi-piece rear part each comprise two outer elements and a middle element arranged offset rearwardly between the two outer elements. The inner side parts 27Ai form a wall delimiting the through opening 30A, with the through opening 30A being only partially surrounded by the cover 20, 20A in the U-shaped embodiment.

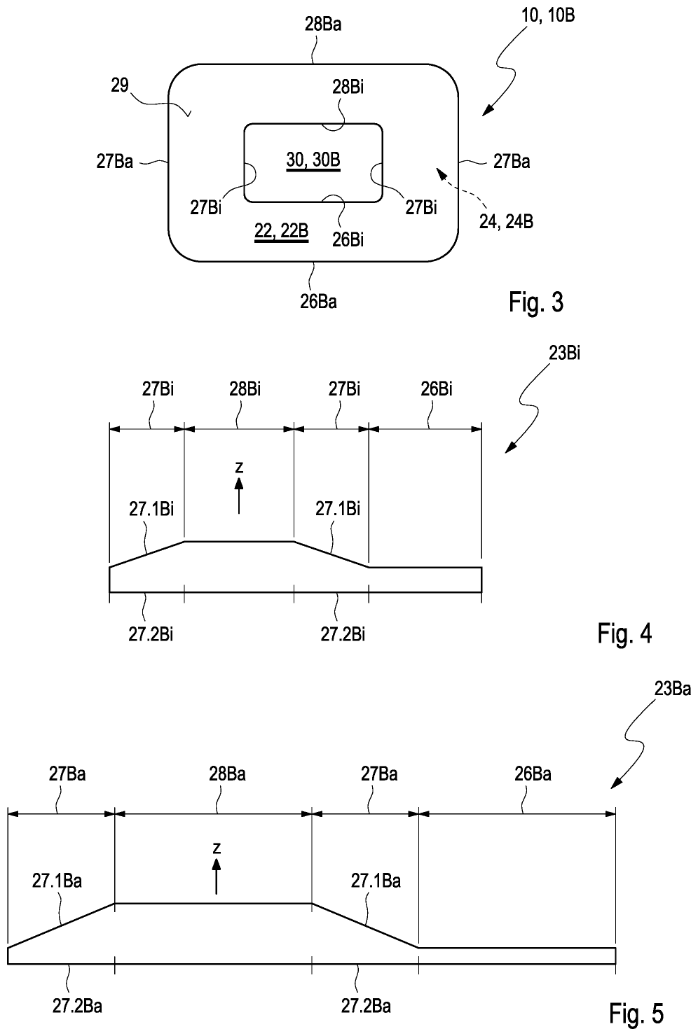

The airbag 10, 10B according to the second embodiment of the invention, illustrated in FIGS. 3 to 5, comprises an O-shaped upper part 22, 22B and an O-shaped lower part 24, 24B. In addition, the cover 20, 20B of the airbag 10, 10B according to the second embodiment of the invention comprises an outer casing part 23Ba which forms two outer side parts 27Ba, a continuous rear part 26Ba, and a continuous front part 28Ba, and an inner casing part 23Bi which forms two inner side parts 27Bi, an inner rear part 26Bi, and an inner front part 28Bi. The inner casing part 23Bi forms a wall delimiting the through opening 30B, with the through opening 30B being completely surrounded by the cover 20, 20B in the O-shaped embodiment.

The airbag 10, 10A, 10B according to the disclosed embodiments of the invention and the airbag arrangement 40 according to the disclosed embodiments of the invention allow the occupant to be protected as well as possible in any seating position, without sacrificing the usual seating comfort by temperature control or ventilation of the ventilation arrangement 44.

The support surface 29 and the inclination of the upper part 22, 22A, 22B and a height of the inflated cover 20, 20A, 20B can be easily predetermined by the casing parts 23, 23A, 23Ba, 23Bi, and various embodiments can be easily implemented.

### LIST OF REFERENCE SIGNS

10, 10A, 10B Airbag
12 Inlet valve
20, 20A, 20B Inflatable cover
22, 22A, 22B Upper part
23, 23A, 23Ba, 23Bi Casing part
24, 24A, 24B Lower part
26, 26A, 26Ba, 26Bi Rear part
27Aa, 27Ba Outer side part
27Ai, 27Bi Inner side part
27.1Aa, 27.1Ai, 27.1Ba, 27.1Bi First leg
27.2Aa, 27.2Ai, 27.2Ba, 27.2Bi Second leg
28, 28A, 28Ba, 28Bi Front part
29 Support surface
30 Cutout
30A, 30B Through opening
32 Air current
40 Airbag arrangement
42 Inflation apparatus
44 Ventilation arrangement
50 Vehicle seat

1-12. (canceled)

13. An airbag for an airbag arrangement of a vehicle seat of a vehicle, comprising:
an inflatable cover comprising an upper part facing a seat surface of the vehicle seat, a lower part facing a vehicle floor of the vehicle, a casing part interconnecting the upper part and the lower part, and a cutout defining a through opening extending from the lower part to the upper part, wherein the inflatable cover is configured to be folded in a standby state and inflated in an operational state,
wherein the inflatable cover is folded during the standby state, the upper part and the lower part lie substantially flat and the casing part is folded in between the upper part and the lower part,
wherein the inflatable cover is inflated during the inflation process, the upper part of the inflatable cover is configured to apply a force against thighs or a pelvic region of an occupant sitting on the vehicle seat such that the thighs or the pelvic region of the occupant is lifted, and the cutout is configured to guide an air current through the inflatable cover, and
wherein the casing part is configured to be shaped during the inflation process of the cover to define a support surface along the upper part for supporting the thighs or the pelvic region of the occupant sitting on the vehicle seat.

14. The airbag according to claim 13, wherein the inflatable cover comprises at least one recess in a region of the casing part or the lower part, and the recess is configured to adapt the inflated cover to an installation environment in the vehicle seat.

15. The airbag according to claim 13, wherein the casing part includes a rear part facing a seat backrest of the vehicle seat, a front part disposed opposite the rear part, a first side part extending from the front part to the rear part, and a second side part extending from the front part to the rear part.

16. The airbag according to claim 15, wherein the cover is inflated during the inflated state, an upper edge of the rear part is disposed lower than an upper edge of the front part in a vehicle vertical direction such that the support surface is inclined toward the seat backrest.

17. The airbag according to claim 15, wherein the first and second side parts each include a first leg connected to the upper part and a second leg connected to the lower part, and the first leg extends at an acute angle with respect to the second leg.

18. The airbag according to claim 13, wherein the inflatable cover completely or partially encloses the cutout.

19. The airbag according to claim 15, wherein the upper part and the lower part are U-shaped or O-shaped.

20. The airbag according to claim 19, wherein the casing part includes a first inner side part and a second inner side part disposed between the first and second side parts,
wherein the rear part extends continuously from the first side part to the second side part, and
wherein the front part includes a first front part extending from the first side part to the first inner side part and a second front part extending from the second side part to the second inner side part such that the upper part and lower part are U-shaped.

21. The airbag according to claim 19, wherein the casing part includes a first inner side part and a second inner side part disposed between the first and second side parts,
wherein the front part extends continuously from the first side part to the second side part, and
wherein the rear part includes a first rear part extending from the first side part to the first inner side part and a second rear part extending from the second side part to the second inner side part such that the upper part and lower part are U-shaped.

22. The airbag according to claim 19, wherein the casing part includes an O-shaped inner side part disposed between the first and second side parts, and
wherein the rear part extends continuously from the first side part to the second side part and the front part extends continuously from the first side part to the second side part such that the upper part and the lower part are O-shaped.

23. An airbag arrangement for a vehicle seat of a vehicle, comprising:
an airbag including an inflatable cover disposed in a seat cushion of the vehicle seat, the inflatable cover is configured to be folded in a standby state and inflated in an operational state; and
an inflation apparatus configured to inflate the inflatable cover of the airbag in response to an accident situation,
wherein the inflatable cover comprises an upper part facing a seat surface of the vehicle seat, a lower part facing a vehicle floor of the vehicle, a casing part interconnecting the upper part and the lower part, and a cutout defining a through opening extending from the lower part to the upper part,
wherein the inflatable cover is folded during the standby state, the upper part and the lower part lie substantially flat and the casing part is folded in between the upper part and the lower part,
wherein the inflatable cover is inflated during the inflation process, the upper part of the inflatable cover is configured to apply a force against thighs or a pelvic region of an occupant sitting on the vehicle seat such that a part of a body of the occupant is lifted, and wherein the casing part is configured to be shaped during the inflation process of the cover to define a support surface along the upper part for supporting the thighs or the pelvic region of the occupant sitting on the vehicle seat.

24. The airbag arrangement according to claim 23, wherein the inflation apparatus includes a ventilation arrangement configured to generate an air current, and the cutout is configured to guide the air current generated by the ventilation arrangement to a seat surface of the seat cushion.
